(19) United States
(12) Patent Application Publication
(10) Pub. No.: US 2021/0394503 A1
(43) Pub. Date: Dec. 23, 2021

(54) METHOD FOR TEACHING AND/OR OPERATING A LAMINATING METHOD AND/OR A LAMINATING DEVICE, METHOD FOR LAMINATING A FILM ELEMENT, METHOD FOR INSTALLING AND RETROFITTING A LAMINATING METHOD AND/OR A LAMINATING DEVICE FOR LAMINATING A FILM ELEMENT, DEVICE FOR LAMINATING A FILM ELEMENT, AND TEACHING STATION AND FILM ELEMENT

(71) Applicant: LISA DRÄXLMAIER GMBH, Vilsbiburg (DE)

(72) Inventors: Andreas JUNG, Laufen (DE); Josef REHRL, Teisendorf (DE); Hubert REHRL, Teisendorf (DE)

(21) Appl. No.: 17/293,284

(22) PCT Filed: Nov. 13, 2019
(86) PCT No.: PCT/DE2019/100979

§ 371 Date: May 12, 2021

(30) Foreign Application Priority Data
Nov. 13, 2018 (DE) 10 2018 128 458.6

(51) Int. Cl. B32B 41/00; B32B 37/00

(52) U.S. Cl. CPC B32B 41/00; B32B 2041/06; B32B 37/0046

(57) ABSTRACT

The present disclosure relates to a method for teaching and/or operating a laminating method and/or laminating device for laminating a film element on a substrate part, in which designated working positions, designated intermediate positions and/or designated end positions into which grippers for gripping the film element are subsequently moved to laminate the film element, are determined and taught by with the aid of CAD data of the substrate part and/or the film element.

### CROSS REFERENCE TO RELATED APPLICATIONS

This application is a national phase application of International Application No. PCT/DE2019/100979 and further claims priority to German patent application 10 2018 128 458.6, both of which are hereby incorporated by reference.

### BACKGROUND OF THE INVENTION

The present disclosure relates to a method for teaching and/or operating a laminating method and/or a laminating device for laminating a film element on a carrier part.

The present disclosure further relates to a method for laminating a film element, in which the film element is gripped by means of grippers, and in which grippers are respectively motor-driven in their working positions, to position the film element in relation to the carrier part for a lamination device.

The present disclosure further relates to a method for installing or converting a laminating method and/or a laminating device for laminating a film element with grippers for gripping the film element.

The present disclosure further relates to a device for laminating a film element with grippers for gripping the film element and with a control device for controlling a motor-driven method of grippers in the working positions thereof, in particular in their intermediate or end positions.

The present disclosure further relates to a teaching station.

The present disclosure further relates to a film element for lamination to a carrier part.

From the prior art, generic processes for laminating a film element as well as corresponding devices for laminating a film element are already known.

For example, a method and device for laminating a film element to a carrier part are known from WO 2017/215684 A1. The device disclosed there comprises, among other things, a plurality of grippers for gripping the film element, wherein the grippers being multi-axially displaceable in order to be able to adapt the film part more precisely to the contour of a component to be laminated.

### BRIEF SUMMARY OF THE INVENTION

The present disclosure is based on the task of further developing, in particular, generic methods and devices. In particular, the aim of the invention is to save film material. The invention further relates to the possibility of laminating a film element without distortion.

According to a first aspect, the task of the invention is solved by a method for teaching a laminating method and/or a laminating device for laminating a film element on a carrier part, wherein designated working positions, designated intermediate positions and/or designated end positions, into which grippers for gripping the film element are later moved for laminating the film element, are determined and taught by means of CAD data of the carrier part and/or of the film element.

With the first solution proposed here, designated working positions, designated intermediate positions and/or designated end positions can be set extremely precisely for grippers when laminating the film element to the carrier part later, so that the carrier part can also be laminated with the film element correspondingly extremely precisely.

By means of the present method, working positions, designated intermediate positions and/or designated end positions required for a lamination process are determined and taught in dependence on corresponding CAD data.

In addition, particularly exact movements and/or positioning of grippers relative to the carrier part and also other components of a laminating tool, such as a carrier part receptacle, a sealing device of a pressure differencing device, a punching device or the like, can be simulated and determined.

Suitable data for generating and teaching designated work positions, designated intermediate positions and/or designated end positions can also be generated and taught cumulatively or alternatively on the basis of data, in particular CAD data, of a laminating tool.

It is understood that suitable data, such as CAD data, can be provided in various ways for the present method. Advantageously, corresponding interfaces are provided on a laminating device, in particular on a vacuum laminating device, for the method to be carried out in order to process the required data there, in particular to read it out or read it in electronically.

It is particularly useful if the CAD data comprises at least one data record for a shape, in particular a contour, such as for example a processing into a surface to be laminated, of the carrier part. Such data sets of the carrier part, in particular data on a free-form surface associated therewith, which is to be laminated, enable the generation of particularly exact/precise designated working positions, designated intermediate positions and/or designed end positions for the grippers.

In this respect, a very advantageous method variant provides that designated working positions, designated intermediate positions and/or designated end positions depend on a shape, a contour, a winding of a surface to be covered, a free-form surface or the like.

Cumulatively or alternatively, the designated working positions, designated intermediate positions and/or designated end positions can also be based on CAD data of the film element, in particular on corresponding data on the outer contour or edge contour of the film element.

In this respect, it is advantageous to determine and teach designated working positions, designated intermediate positions and/or designated end positions depending on a shape, in particular an outer contour or an edge contour, of the film element.

In the sense of the invention, the term “CAD data” means any electronically processable data, which can contain and provide useful information to generate and, in particular, to teach designated working positions, designated intermediate and/or designated end positions. This includes, in particular, data from a computer-aided geometric model or the like, in particular, 3D CAD data.

The terms “working positions”, “intermediate positions and “end positions” essentially describe at least spatial positions on a laminating device, in particular on a laminating room of the laminating device, at or in which grippers for gripping a film element for producing a laminated component can be temporarily placed on the correspondingly equipped laminating device. In this respect, the present designated working positions, intermediate positions and/or end positions are stationary positions at or in which laminating film grippers can be moved and placed for subsequent lamination.

In the sense of the invention, the term “designated” describes any future gripper positions in which grippers for a later lamination process can initially be arranged in a simulated manner. These gripper positions are primarily designated working positions within the meaning of the invention, but can also be designated intermediate positions and/or designated end positions or the like.

In the sense of the invention, the term “teaching” describes a process, in particular with regard to a laminating method or a laminating device, in which individual or preferably all grippers involved in a lamination process are guided and arranged outside of an automated lamination process, pre-designated working positions, designated intermediate positions and/or designated end positions.

In other words, this means that the grippers can be guided by human interaction.

The present invention allows designated working positions, designated intermediate positions and/or designated end positions to be entered in a controller or the like in a very simple manner, preferably stored and, moreover, stored permanently or temporally at least for as long as desired in the controller.

According to a second aspect, the aim of the invention is also achieved by a method for teaching a method and/or a device for laminating a film element on a carrier part, wherein designated working positions designated intermediate positions and/or designated end positions, in which grippers for gripping the film element are later moved into the film element for laminating the film element, are taught by means of individual spatial coordinates.

Cumulatively or alternatively to the first solution, individual spatial coordinates can be provided in the second proposed solution, on which the designated working positions partially or fully support designated intermediate and/or designated end positions.

By entering such spatial coordinates, designated working positions, designated intermediate positions and/or designated end positions can additionally be individually adapted, for example as an alternative to CAD data or cumulatively to existing CAD data.

For example, it is possible to manipulate one or more designated work positions, designated intermediate positions and/or designated end positions created on the basis of CAD data by independent, preferably manually entered spatial coordinates.

The term “space coordinates” describes places on a laminating device, in particular on a vacuum laminating device, which are located, in particular, directly next to a laminating tool or in a laminating room of the laminating device.

These spatial coordinates can be fixed in place, but can also be movable locally depending on time. In addition to statically provided designated working positions, designated intermediate positions and/or designated end positions, dynamically variable designated working positions, Create designated intermediate positions and/or designated end positions.

It is advantageous to generate designated working positions, designated intermediate positions and/or designated end positions by means of at least two or more spatial coordinates, preferably by means of a starting point and an end point and a plurality of waypoints arranged in between.

Any spatial coordinates can be entered in various ways at a laminating device or on a device periphery thereof. For example, such an input of spatial coordinates takes place as numerical inputs. Alternatively, locations are selected directly on a correspondingly prepared graphic representation of a laminating device, in particular a laminating room thereof, or selected on the input device.

It has also proved to be particularly advantageous if spatial coordinates are entered manually by means of an input device, in particular by means of a manual input device, such as a graphical surface of an input device.

Cumulatively or alternatively, it is advantageous if the designated working positions, intermediate positions and/or end positions are taught by means of a manual interaction movement at and/or in front of a graphic surface of an input device. This also makes it easy to teach the desired designated working positions, designated intermediate positions and/or designated end positions.

According to a third aspect, the aim of the invention is also achieved by a method for teaching a method and/or a device for laminating a film element on a carrier part, wherein designated working positions designated intermediate positions and/or designated end positions into which grippers for gripping the film element, in particular at least one gripper jaw element thereof, are subsequently moved for laminating the film element, are taught by manual actuation of grippers.

Cumulatively or as an alternative to the first and second solution, grippers can also be moved manually, in the third solution proposed here, i.e. only manually, in order to teach suitable designated working positions, designated intermediate positions and/or designated end positions.

In this respect, further advantageous method is that the grippers are manually guided to predetermined spatial coordinates and to be placed there manually at said spatial coordinates, enabling the designated working positions, designated intermediate positions and/or designated end positions to be individually determined.

Through this teaching process, designated working positions, designated intermediate positions and/or designated end positions can be generated significantly faster and more accurately than has previously been the case with pure programming in lamination processes. In particular, in the case of test runs, it is determined that gripper movements do not run optimally on the basis of previously generated programming.

According to a fourth aspect, the aim of the invention is also achieved by a method for laminating a film element on a carrier part, wherein the film element is gripped by means of grippers, and in which grippers are motor-driven in each of their respective working positions, in order to position the film element for a lamination process with respect to the carrier part, wherein the method is characterized in that grippers are least partially guided individually or combined into respectively designated working positions, in particular into designated intermediate or end positions, in order to teach designated working positions.

The fact that grippers, in particular of a laminating device, pass through a teach-in phase independently of a laminating process means that the corresponding grippers can be easily taught, in particular to designated working positions.

By means of the method proposed here according to the fourth aspect, in particular also in combination with one of the other proposed methods, an advantageous lamination method variant is available by means of which a film element to be laminated on a carrier part can be brought into effective contact with the carrier part in an improved manner and can then be laminated in such a way that a considerable saving in film material can be achieved as a result.

Among other things, this is also due to the fact that the grippers can grip the film element more closely at its laminating area during a later or the actual subsequent laminating process, whereby waste at the edge area of the film element can be significantly reduced.

In particular, the invention allows a control system associated with the laminating device to be taught in advance for the automated movement of the grippers during the laminating process with regard to the working positions to be adopted by the grippers during this laminating process.

Advantageously, a costly and complex programming process based on often estimated individual data regarding the working positions to be approached by grippers during the laminating process can be significantly simplified or, preferably, completely eliminated, whereby, in particular, a laminating process or a laminating device can be significantly simplified during a product change.

According to a fifth aspect, the task of the invention is also solved by a method for or retrofitting a laminating method for laminating a film element and/or a laminating device for laminating a film element with grippers for gripping the film element, in which grippers used for mounting or retrofitting in the laminating method and/or in the laminating device are guided at least partially individually or combined into designated working positions, in particular into designated intermediate or end positions, in order to teach designated working positions in each case.

It is advantageous to teach particularly well-designed work positions before laminating a film element, especially in the integration of a retrofit or conversion.

By means of the further method proposed here according to the fifth aspect of the invention, at least one further method variant is available which can be advantageously designed by means of the present teaching-in of particular working positions.

By means of the present invention, special grippers can be optimally taught in terms of their designated working positions before any laminating method and/or device is even put into operation at all.

In this respect, a lamination process is initially only simulated with regard to gripper positions.

In the sense of the invention, the term “designated working positions” describes any future gripper positions in which grippers can be positioned for a subsequent lamination process. In particular, these can also be designated intermediate or end positions.

At this point it should be mentioned that the term “lead in” means a manually controlled guiding of grippers by human hands. It goes without saying that such manual “manual guidance” can take place in different ways.

In particular, the expression “lead” in the sense of the invention means a movement or spatial movement or positioning of one or more grippers, individually or in groups, preferably initiated in an offset mode, for simulation purposes, for example.

Thus, a method variant provides that grippers are manually guided at least partially individually or combined into respective designated working positions. For example, grippers are manually gripped to teach their respective designated working position and manually guided or transferred for teaching to the designated working position.

An even more effective and thus preferred method variant provides that grippers are driven, at least partially, individually or in combination, into the respective designated working position by means of a manually actuated control device. Here, the grippers can be guided not only by muscle force, but cumulatively or alternatively manually motor-assisted.

The present methods can be carried out in a particularly simple manner if grippers are guided at least partially individually or in combination into respectively designated working positions without the use of a film.

In this respect, a preferred method variant provides that grippers are guided at least partially individually or in combination into respectively designated working positions in order to teach designated working positions before gripping a film element to be laminated. In particular, designated working positions can be determined before laminating a film element on a carrier part and can be taught, stored and held for a subsequent lamination process.

It is therefore advantageous if grippers are guided at least partially individually or in combination into respectively designated working positions in order to teach in respectively designated working position of the grippers prior to the lamination method and/or a laminating device.

The methods can be carried out in a particularly comprehensive manner if grippers are at least partially guided individually or in combination, into respectively designated working positions in order to teach a control device for controlling a laminating method and/or a laminating device, in particular for controlling grippers, with regard to designated work positions.

In particular, by means of a relevant control device, the taught, designated working positions can be reproduced almost as often as desired.

Furthermore, on the one hand particularly good savings effects in film material and on the other hand very distortion-free lamination can be achieved if grippers are guided at least in part individually or in combination up to or against a vacuum room, in particular up to 20 mm or up to 15 mm, preferably up to 5 mm or less, to a vacuum room, and/or another component of a lamination tool, in order to teach designated working positions.

Film blanks for film elements can be produced in a particularly small, film-material-saving manner and thus targeted manner and provided for lamination if grippers are at least partially guided individually or in combination to a sealing device of a vacuum room and/or other component of a laminating tool in order to teach designated working positions.

Alternatively, it is useful if grippers are at least partially individual or n combination up to a cutting device of a laminating room, in particular up to 20 mm or up to 15 mm, preferably up to 5 mm or less, to a cutting device of a laminating room, in particular up to 20 mm or up to 15 mm, preferably up to 5 mm or less, to a cutting device of a laminating room and/or another component of a laminating tool in order to teach designated working positions. A correspondingly small distance can reduce the risk of critical contact between, for example cutting slide elements of the cutting device and grippers during a laminating process, and yet grippers can still be placed very close to a vacuum room so that film elements can be cut to advantageously small sizes.

A further advantageous method variant provides that grippers are guided at least partially individually or in combination from predefined starting positions into respectively designated working positions and/or designated intermediate positions, and/or designated end positions. Basically, the grippers can be guided from any starting position into designated working positions and/or designated intermediate positions and/or designated end positions and temporarily moved there in accordance with the invention. However, later starting lamination processes can be carried out even more reliably or more precisely if grippers from predefined starting positions are moved to designated working positions and/or designated intermediate positions, and/or designated end positions.

Further improvement of the proposed methods can be achieved by reading data, in particular 3D data, from a workpiece into a control device for controlling a laminating device, in particular for controlling grippers for gripping the film element, to teach from designated working positions and/or designated intermediate positions and/or designated end positions. If, for example, data or 3D data are available from a film element, a carrier part or a laminated component, the methods can be carried out even more precisely using this information.

If grippers are guided into designated working positions and/or designated intermediate positions and/or designated end positions at least partially individually or in combination depending on the contour of a carrier part, especially designated working positions can be taught even more precisely. This also makes it possible to cut film elements even more precisely, which allows film material to be saved even more effectively.

Cumulatively or alternatively, specially designated working positions can be taught more precisely if grippers are at least partially guided individually or in combination, into designated working positions and/or designated intermediate positions, and/or designated end positions, depending on the movement of a carrier part.

At this point, it should be explicitly pointed out that advantageously designated working positions, designated intermediate positions and/or designated end positions are offset, whereby teaching in the sense of the invention can take place in advance of an actual machine and automated lamination process.

According to a sixth aspect, the aim of the invention is achieved by a device for laminating a film element with grippers for gripping the film element and by a control device for controlling a motor-driven method of grippers in their respective working positions, in particular in their respective intermediate or end positions, whereby the device is characterized by a control device for carrying out the method described here.

By means of the laminating device, the respective method for teaching designated working positions of grippers can be easily carried out before the actual laminating process and real laminating processes can then be carried out thereon. By means of the correspondingly designated laminating device, a laminating process with regard to gripper positions is therefore initially only simulated.

In the sense of the invention, the term “laminating device” describes any device by means of which a film element can be laminated onto a carrier part to form a laminated component. Such a laminating device relates in particular to a vacuum laminating device, but can also relate to other laminating machines.

According to a seventh aspect, the aim of the invention is also achieved by a teaching station for teaching designated working positions for grippers for gripping a film element, with grippers and/or with gripper dummies, and with a control device for controlling the teaching station, in particular the gripper and/or the gripper dummies, wherein the teaching station is characterized by a control device for carrying out the present method.

By means of the present teaching station, the respective method for teaching designated working positions of grippers can be carried out independently of a laminating device and the determined designated working positions can be carried out in a corresponding control device, in particular a laminating device for later retrieval. This means that a laminating device is ready for use again significantly faster, especially after a product change.

By means of the teaching station, a lamination process is preferably simulated with regard to gripper positions within a lamination room, but no real lamination process is subsequently carried out.

Furthermore, grippers at the present teaching station are more easily accessible due to the complexity of the teaching station, which makes manual guiding of the grippers into designated work positions even easier.

Preferably, the teaching station has a simulation room in which the grippers can be guided.

The simulation room preferably corresponds to a laminating room of a laminating device.

In order to freely switch grippers for guiding to designated working positions, designated intermediate positions and/or designated end positions in a laminate room, it is advantageous that the control device comprises means for releasing grippers.

Both the device for laminating and the teaching station each embody an advantageous teaching device for teaching in particular designated working positions of a corresponding laminating process, which can also be integrated into a processing line of a system for producing laminated components.

The device or the teaching station can be advantageously operated for teaching designated working positions if the control device comprises a redundant control device. By means of the redundant control device, grippers can be guided into designated working positions, for example, independently of control devices installed in a laminating machine or the like.

For example, a correspondingly configured redundant control device has a mirrored display of a stationary output device of the device or of the teaching station.

It is particularly useful for operating the device or the teaching station or for carrying out the present method if such a redundant control device is mobile.

In this respect, an advantageous embodiment provides that the control device comprises a mobile input device, in particular a handheld device. A suitable handheld device can be in particular a laptop, a tablet or the like, but also a smartphone or similar.

If the control device comprises a keyboard control, a touch screen control, a joystick control or the like, grippers can be guided into designated working positions in a motor-assisted manner by means of human interaction particularly easily.

In any case, grippers are guided into designated working positions, in designated intermediate positions and/or in designated end positions within a laminating room, in the sense of the invention, by interaction of an operator carrying out the respective laminating method.

A preferred embodiment further provides that the control device comprises an interface for receiving and processing data of a carrier part to be laminated and/or a film element, whereby designated working positions designated intermediate positions and/or designated end positions can be advantageously determined and taught by the control device on the basis of data determined therefrom, in particular CAD data.

It is useful if the interface can receive and process structural data, in particular CAD data, unwinding data, free-form surface data or the like of a film element to be laminated, a carrier part to be laminated and/or a carrier part receptacle. This allows designated working positions, designated intermediate positions and/or designated end positions to be determined and taught even more accurately.

Furthermore, it is also advantageous if the interface is designed to receive and process structural data, in particular CAD data, of a laminating room, in particular a vacuum room of the laminating room, a sealing device of the laminating room, a cutting device of the laminating room or the like. This also allows designated working positions, designated intermediate positions and/or designated end positions to be determined and taught more accurately.

A further very advantageous embodiment variant provides that designated working positions, designated intermediate positions and/or designated end positions are dependent on a vacuum room, in particular an outer contour of a vacuum room, can be determined and taught. As a result, designated working positions, designated intermediate positions and/or designated end positions can be further optimized, taking into account spatial conditions in a laminating room of a laminating device, especially with respect to a vacuum room of a laminating device. In particular, positional positions of the vacuum room or components or component groups thereof are advantageously utilized for this purpose.

The vacuum room and in particular an outer contour, preferably a changeable outer contour, of the vacuum room can be advantageously displaced within the laminating room, in particular height-shifted.

Cumulatively or alternatively, it is advantageous if designated working positions, designated intermediate positions and/or designated end positions are determined and taught as a function of designated position positions, in particular of variable position positions, of sealing elements of a sealing device and/or of cutting elements of a cutting device. Designated working positions, designated intermediate positions and/or designated end positions can also be further optimized in this way, taking into account spatial conditions on a sealing device and/or a cutting device of a laminating device. This is of particular advantage on a laminating device, since such devices or components or component groups thereof are arranged extremely close together in a laminating room or on a vacuum room so that especially precisely matched designated working positions, designated intermediate positions and/or designated end positions can further improve a lamination process.

A further advanced embodiment provides that designated working positions, designated intermediate positions and/or designated end positions can be determined and taught as a function of a designated dynamic laminating movement of a carrier part receptacle and/or a carrier part. As a result, a film element to be laminated and a carrier part to be laminated therewith can be placed within a laminating room in an even more individual, dynamic and thus even better matched to one another, so that a lamination process can be further individualized. Thus, it is also advantageous if designated working positions, designated intermediate positions and/or designated end positions can be determined or taught as a function of a preferably multidimensionally manipulable travel path of a carrier part holder or a carrier part.

If cumulatively or alternatively designated working positions, designated intermediate positions and/or designated end positions can be determined and taught as a function of a distance, in particular an individually adjustable distance, between an edge contour of a film element and an outer contour of a vacuum room, and/or sealing elements of a sealing device, and/or cutting elements of a cutting device, favorable film material savings and/or improved laminating results can also be achieved.

In any case, it is advantageous if designated working positions, designated intermediate positions and/or designated end positions can be determined and taught as a function of, in particular, closing movements of a laminating tool, preferably of closing movements of a lower tool of the laminating tool and/or of an upper tool of the laminating tool, whereby, in particular, the present laminating processes can be improved.

According to an eighth aspect, the object of the invention is also achieved by a film element for laminating onto a carrier part, the film element having an outer contour, and the outer contour of the film element being generated as a function of data of a carrier part contour of a carrier part.

If the outer contour of the film element is dependent on a carrier part contour, it can be produced, the film element can be packaged in an exceptionally saving manner and thus more precisely and also scarce, whereby waste of film material can be significantly reduced or ideally minimized. This can be laminated Components with a significantly reduced material expenditure and therefore cost-saving and more economical to manufacture.

The film element can be matched even more precisely to the carrier part to be laminated if the film element has a circumferential edge contour, the circumferential edge contour being generated as a function of data of a carrier part contour of a carrier part.

If the data of the carrier part contour include structural data, in particular CAD data, processing data, free-form surface data or the like of the carrier part, not only can the film element be made more scarce with regard to the carrier part, but also, depending on such structural data, also designated working positions, designated intermediate positions and/or designated end positions can be better determined and taught in the sense of the present invention.

It goes without saying that features of the solutions described above or in the claims can also be combined, if necessary, in order in particular to be able to implement the advantages and effects which can be achieved in accordance with the invention.

At this point it should also be mentioned that within the scope of the present patent application, the expression “in particular” should always be understood in such a way that an optional, preferred feature is introduced with this expression. The expression is not to be understood as “and” and not as “namely”.

Furthermore, it should be pointed out that in the context of the present patent application, indefinite articles and indefinite numbers such as “one . . . ”, “two . . . ” etc. should generally be understood as at least information, i.e. as “at least one” . . . “,” at least two . . . etc., unless it is clear from the context or the specific text of a particular passage that it means only “exactly one . . . ”, “exactly two . . . ” etc. should be.

Furthermore, it should also be claimed that the methods described can also be supplemented by further technical features described here, in particular by features of the device, in order to advantageously further develop the methods or to be able to represent or formulate method specifications even more precisely, or vice versa.

It should also be explicitly stated that the present invention relates to a real or simulated lamination room, on or in which existing designed working positions, designated intermediate positions and/or designated end positions are generated.

In addition, further features, effects and advantages of the present invention are explained with reference to the attached drawing and the following description, in which, by way of example, a device for laminating a film element onto a carrier part is illustrated and described.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

The drawing shows:

FIG. 1 depicts schematically a view of a device for laminating a film element on a carrier part with a plurality of grippers;

FIG. 2 depicts a schematic of a supervision of a teaching station with a laminating room and with a large number of grippers;

FIG. 3 depicts a schematic of a top view of a gripper of the one shown in FIGS. 1 and 2 device or teaching station;

FIG. 4 depicts a schematic of a side view of the gripper shown in FIG. 3; and

FIG. 5 depicts a schematic of a first conceivable process sequence for teaching designed working position on a laminating device.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” would be understood as including only one of A, only one of B, only one of C, or any combination of A, B, and C.

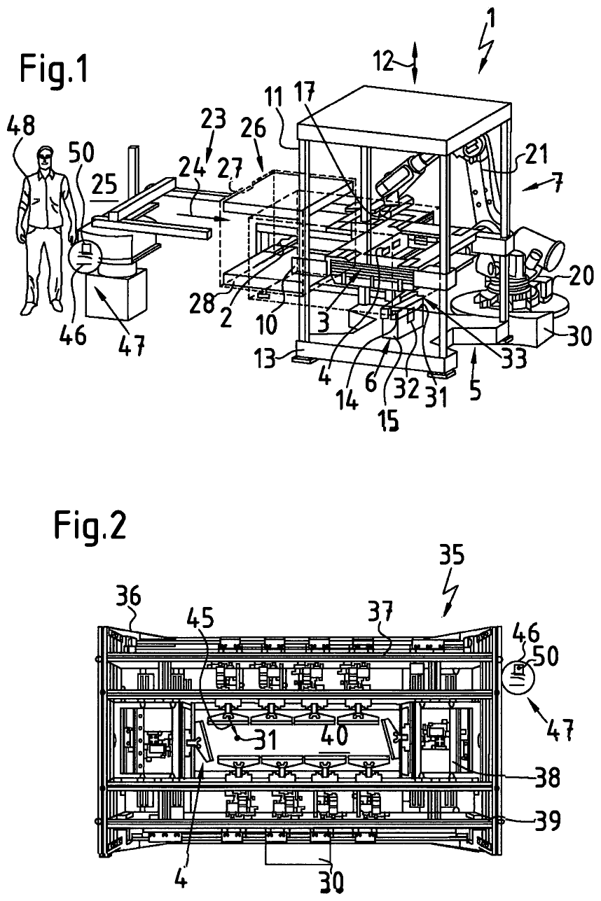

As depicted in FIG. 1, a first possible exemplary embodiment of a device 1 for laminating a film element 2 is shown.

The device 1 comprises a frame part 3 with a plurality of motor-driven grippers 4. Alternatively, the motor-driven grippers 4 can also be held independently of a common frame part 3 on the device 1.

The device 1 is further characterized by a laminating tool 5 with a lower tool 6 and with an upper tool 7.

The lamination tool 5 has a lamination room 8, in which a lamination process or a lamination process takes place.

The frame part 3 and thus also the grippers 4 are mounted height-adjustable in a frame 11 of the device 1 by means of a travel mechanism 10, so that the entire frame part 3 is mounted on the frame 11 in a height-adjustable manner along a vertical displacement axis 12 of the device 1.

Below the frame part 3 on a bottom part 13 of the frame 11, the lower tool 6 is placed, the lower tool 6 comprising one or more molded shell parts 14, which in turn are arranged on a base 15 of the bottom part 13.

The upper tool 7 comprises a carrier part receptacle 16, by means of which one or more carrier parts 17 to be laminated can be held on the upper tool 7. The upper tool 7 also has a robot device 20 with a multi-axially movable manipulator 21, to which the carrier part receptacle 16 is fastened. The carrier part receptacle 16 can be brought into the laminating room 8 by means of the multi-axially movable manipulator 21. In particular, the carrier part receptacle 16 can be moved multidimensionally within the laminating room 8, in particular also adjustable in height.

In addition, the device 1 also has a feed and/or insertion device 23, by means of which one or more film elements 2 can be introduced into the frame part 3, in such a way that the film element 2 can be immediately inserted into the open gripper 4.

The feeding and/or inserting device 23 has a feeding and/or inserting section 24, along which the respective film element 2 can be fed starting from a loading position 25 into the gripper 4.

The feed and/or insertion device 23 is also characterized by at least one movable heating unit 26 for heating the respective film element 2 outside the frame part 3. The movable heating unit 26 has two heating devices 27 and 28, which can be moved along with the film element 2 to be introduced in the direction of the cutting room 8.

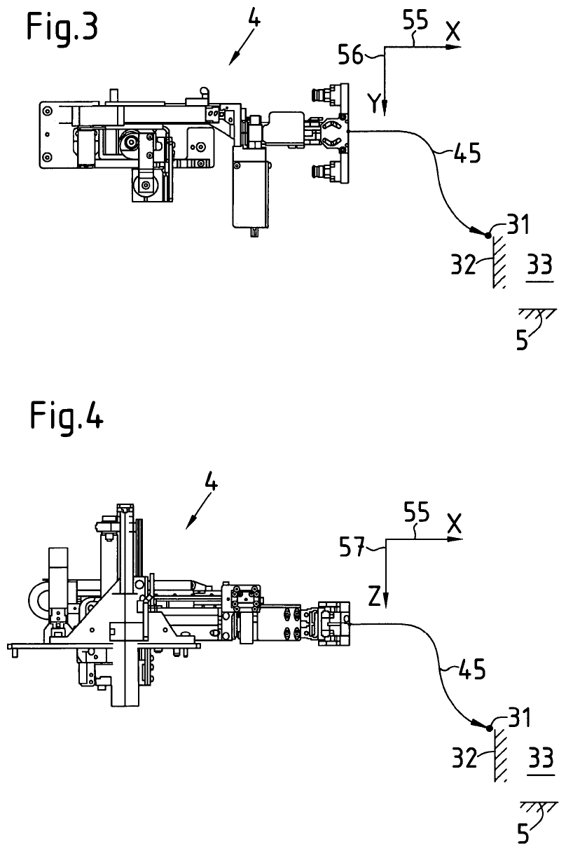

Furthermore, the device 1 has a control device 30 comprising a data interface for motorized movement of the grippers 4 in their respective working positions 31 (numbered here only as an example, see also FIGS. 2 to 4). The working position 31 shown here characterizes, purely by way of example, an end position (not numbered again) of a gripper 4 next to a sealing device 32 (see FIGS. 3 and 4) for sealing a vacuum room 33 (see FIGS. 3 and 4) or besides another one not explicitly here shown and numbered component of the laminating tool 5.

An alternative clamping device is shown in FIG. 2, where a teaching station 35 for teaching designated working positions 31 for grippers 4 for gripping a film element 2 is shown. It goes without saying that dummy grippers can also be used in such a teaching station 35, since no real lamination processes take place at the teaching station 35.

The teaching station 35 has a frame 36, by means of which the grippers 4 are mounted on longitudinal cross members 37 and cross members 38 of a frame part 39 in a multi-axially movable manner.

The frame part 39 or the frame 36 convert a simulation room 40 accessible from above and below, in which the grippers 36 can be guided, the simulation room 40 corresponding to the lamination room 8 of the device 1.

The teaching station 35 has a control device 30 for controlling the grippers 4, this control device also having a data interface (likewise not shown here) in the sense of the invention.

Using the teaching station 35, the grippers 4 and in particular the control device 30 can be taught on designated working positions 31, for this purpose the grippers along trajectories 45 (numbered only as an example, cf. also FIGS. 3 and 4) to the respectively designated working positions 31 can be performed. Subsequently, the designated working positions 31, but also the movement paths 45 are stored by the control device 30 and are available as a data record for a device 1 for laminating a film element 2 on a carrier part 17.

It goes without saying that 35 different teaching methods can be carried out both by means of the device 1 and by means of the teaching station 35.

In this case, the grippers 4 can be guided at least partially individually or in combination into each designated working position 31.

Cumulatively or alternatively, the grippers 4 can be guided by means of a manually operated control device 46 by motor, at least in part individually or in combination, into designated working positions 31.

For this purpose, both the device 1 and the teaching station 35 each have a corresponding redundant control device 46, which in this embodiment is designed as a mobile input device 47. This allows an operator 48 (only shown in FIG. 1) move freely on the device 1 or the teaching station 35 while he manually guides the gripper 4.

More precisely, the input device 47 is a handheld device (not again with reference number) with a joystick control 50, so that the operator 4 grips the gripper 4 with the aid of drive motors (not numbered), the gripper 4 can be very precisely manually lead into the respective working positions 31.

Cumulatively or alternatively, the grippers 4 can be guided at least in part individually or in combination by means of individual spatial coordinates into designated working positions 31, designated intermediate positions and/or designated end positions.

Cumulatively or alternatively, the grippers 4 can be guided by CAD data of the carrier part 17 and/or the film element 2, at least in part, individually or in combination by motor into respectively designed working positions 31, designated intermediate positions and/or designated end positions. Corresponding CAD data can be processed by means of the data interface of the control device in the sense of the invention.

According to the representations according to FIGS. 3 and 4, a gripper 4 is shown as an example in its starting position 54, which, in the sense of the present invention, is guided along the movement path 45 into a designated working position 31 and placed or arranged there at least temporarily.

FIG. 3 shows both the horizontal forward movement 55 (x-axis) and a horizontal sideways movement 56 (y-axis) of the gripper 4 along the movement path 45 and into the designated working position 31, which in a later real lamination process an end position of the gripper 4.

FIG. 4 also shows the horizontal forward movement 55 (x-axis) as well as a vertical downward movement 57 (z-axis) of the gripper 4 along the movement path 45 and into the designated working position 31.

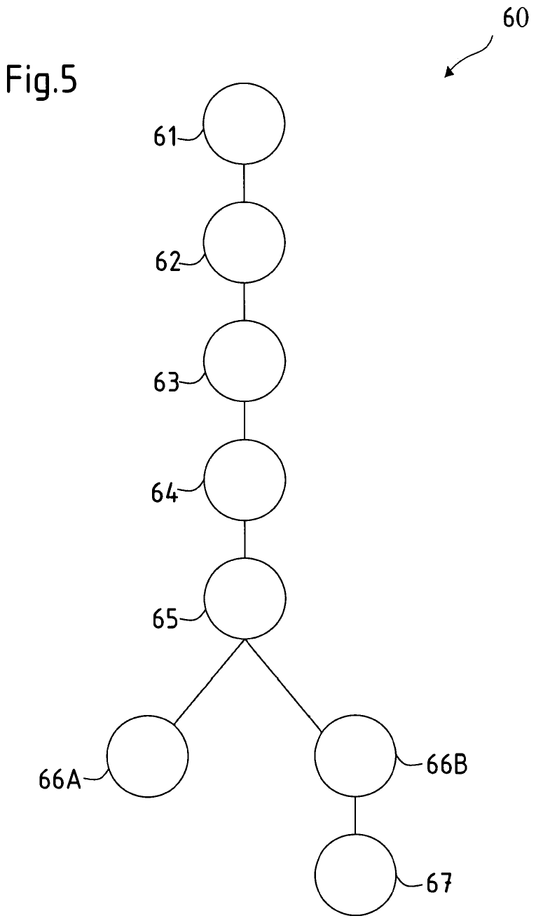

According to the illustration according to FIG. 5, a flow chart 60 is also exemplarily illustrated with a possible process sequence for teaching designated working positions 31 for grippers 4 of the device 1.

In a first method step 61, the grippers 4 are in their respective starting position 54, which can be predetermined or random.

In a second method step 62, drive motors or the like of the grippers 4 are released, so that the grippers 4 are free to move and can be guided in the sense of the invention.

In a third method step 63, grippers 4 are preferably guided individually and manually into their designated working positions 31.

In a fourth method step 64, these designated working positions 31 are detected and stored by the control device 30. The control device 30 has now been taught in particular.

In a fifth method step 65, the grippers 4 taught in this way are moved back from their designated working positions 31, for example into their respective starting position 54.

In a sixth process step 66A, the actual lamination process is started in real life without a previous test run. Or in an alternative sixth method step 66B, the taught grippers 4 first run through a test run in the device 1 with regard to a real laminating process.

In a seventh method step 67, the actual lamination process can actually be started after a successful test run.

The laminating device 1 or teaching station 35 shown here by way of example, as well as the exemplary flow chart 60 can, with suitable adaptation, implement all of the design and process variants described here, where the description of the figures described in detail in this regard is dispensed with in order to avoid repetition.

It goes without saying that the exemplary embodiments explained above are merely first embodiments of the invention. In this respect, these examples do not limit the invention.

At this point, it should again be explicitly pointed out that features of the solutions described above or in the claims and/or figures can also be combined, if appropriate, in order to be able to implement or achieve the described or further features, effects and advantages in a correspondingly cumulative manner.

All the features disclosed in the application documents are claimed as essential to the invention, provided that they are new to the prior art, individually or in combination with one another.

1. A method for at least one of teaching a laminating method for laminating a film element on a carrier part and operating a laminating device for laminating the film element on the carrier part, the method comprising the steps of:
determining and teaching at least one of in which designated working positions, designated intermediate positions and designated end positions to laminate the film using at least one of CAD data of the carrier part and the film element; and
determining and teaching which grippers are configured for gripping the film element and later lamination of the film element.

2. The method according to claim 1, wherein the CAD data comprises at least one data record relating to at least one of a shape and a contour, and wherein at least one of the shape and the contour comprise a development of a surface of the carrier part to be laminated.

3. The method according to claim 1, further comprising the steps of determining and teaching the at least one of the designated working positions, the designated intermediate positions and the designated end positions depending on a shape on an outer contour or an edge contour of the film element.

4. A method for teaching a laminating process and for operating a laminating device for laminating a film element on a carrier part, comprising the steps of teaching by moans of individual special coordinates at least one of designated working positions, designated intermediate positions, designated end positions, and grippers configured for gripping the film element and later for laminating the film element.

5. A method for at least one of teaching a laminating process for laminating a film element on a carrier part and operating a laminating device for laminating the film element on the carrier part, the method comprising the steps of:
teaching in which at least one of designated working positions, designated intermediate positions and designated end positions to laminate the film element on the carrier part by manual actuating of grippers; and
teaching which grippers are configured for gripping the film element and later for laminating the film element on the carrier part by manual actuating of grippers.

6. The method according to claim 5, wherein the grippers are configured to be guided to predetermined spatial coordinates and placed manually at the spatial coordinates.

7. The method according to claim 1, wherein the grippers are configured to be guided at least partially individually or in combination into at least one of designated working positions, designated intermediate positions, designated end positions, to enable teaching of designated working positions.

8. The method according to claim 1 wherein the grippers are configured to be used for scoring or retrofitting at least one of the laminating method, the laminating device and to be guided at least partially individually or in combination at least one of along designated working positions into designated intermediate positions, and into designated end positions, in order to enable the teaching of designated working positions.

9. that the method according to claim 1, wherein the grippers are configured to be moved at least partly individually or in combination into each designated working position.

10. that the method according to claim 1, wherein the grippers are configured to be at least partially guided into designated working positions in a motor-driven manner by means of a manually operated control device.

11. The method according to claim 1, wherein grippers are configured to be guided without film at least partially individually or combined into respectively designated working positions.

12. The method according to claim 1, wherein the grippers are configured to be guided at least partially individually or in combination into designated working positions so as to enable the teaching of designated working positions before gripping the lamination of the film element to be cashed.

13. The method according to claim 1, wherein the grippers are configured to be at least partially guided individually or in combination into designated working positions to enable the teaching of designated working positions of the grippers being put into operation before at least one of the lamination method and a laminating device.

14. The method according to claim 1, wherein the grippers are configured to be guided at least partially individually or in combination into designated working positions to enable instructing a control device configured for controlling at least one of the laminating process and the laminating device configured for controlling grippers with regard to designated working positions.

15. The method according to claim 1, wherein the grippers are configured to be guided at least partially individually or in combination up to at least one of a sealing device of a vacuum room up to 20 mm or up to 15 mm to the sealing device, and up to 5 mm or less to a sealing device of a vacuum room and another component of a laminating tool to enable the teaching of designated working positions.

16. The method according to claim 1, wherein the grippers are configured to be guided at least partially individually or in combination up to at least one of up to 20 mm, up to 15 mm and up to 5 mm or less to at least one of a cutting device of a laminating room and another component of a laminating tool, to enable the teaching of designated working positions.

17. The method according to claim 1, wherein the grippers are configured to be at least partially guided individually or in combination from predefined starting positions into at least one of designated working positions, designated intermediate positions, and designated end positions.

18. The method according to claim 1, further comprising the steps of, for teaching at least one of designated working position, designated intermediate positions and designated end positions, reading at least one of data and 3D data of a workpiece into a control device configured for controlling at least one of a laminating device and the grippers configured for gripping the film element.

19. The method according to claim 1, wherein the grippers are configured to be at least partially guided individually or in combination into at least one of designated working positions, designated intermediate positions and designated end positions as a function of a contour of a carrier part.

20. The method according to claim 1, wherein the grippers are configured to be at least partially guided individually or in combination, depending on a movement of a carrier part, into at least one of designated working positions, designated intermediate positions and designated end positions; and wherein at least one of the designated working positions, designated intermediate positions and designated end positions are offset.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
